(19) United States
(12) Patent Application Publication
(10) Pub. No.: US 2009/0251570 A1
(43) Pub. Date: Oct. 8, 2009

(54) APPARATUS AND METHOD FOR NOISE REDUCTION

(76) Inventor: Miaohong SHI, Tainan (TW)

Correspondence Address: STOUT, UXA, BUYAN & MULLINS LLP, 4 VENTURE, SUITE 300, IRVINE, CA, 92618, US

(21) Appl. No.: 12/061,582

(22) Filed: Apr. 2, 2008

(51) Int. Cl. H04N 5/217

(52) U.S. Cl. 348/241; 348/E05.078

(57) ABSTRACT

Apparatus and method for noise reduction are disclosed. Noise and edge of luma component of a pixel are detected, and noise of chroma component of the pixel is also detected. Subsequently, the noise is removed from the luma and the chroma components according to the detected noise and the detected edge.

### BACKGROUND OF THE INVENTION

1. Field of the Invention

The present invention generally relates to noise reduction, and more particularly to noise reduction along detected edge.

2. Description of the Prior Art

As noise generated by various sources always exists in most imaging sensors, the noise reduction is an essential operation in digital image processing. However, the noise reduction poses the problem of blurring the image, especially at the edges or detail information in the image. The object of the noise reduction is therefore to remove noise as much as possible while degrade the image as little as possible.

A linear method approaching this object in the prior art is convolving the original image with a mask. However, this method, albeit its popularity, gives the image a blurred appearance, especially at the edges.

For the foregoing, a need has arisen to propose an edge-preserving way, which is fast and effective for noise reduction.

### SUMMARY OF THE INVENTION

In view of the foregoing, it is an object of the present invention to provide a fast and effective way for noise reduction while preserving the edges and detail information.

According to the embodiment of the present invention, noise and edge of luma component of a pixel are detected, and noise of chroma component of the pixel is also detected. Subsequently, the noise is removed from the luma and the chroma components according to the detected noise and the detected edge.

### BRIEF DESCRIPTION OF THE DRAWINGS

FIG. 1 shows a block diagram illustrating apparatus for noise reduction according to one embodiment of the present invention;

FIG. 2 shows a flow diagram illustrating a method for noise reduction according to the embodiment of the present invention; and

FIG. 3 shows an exemplary and simplified image having 3×3 pixels, among which the pixel X₅ is subjected to noise reduction.

### DETAILED DESCRIPTION OF THE INVENTION

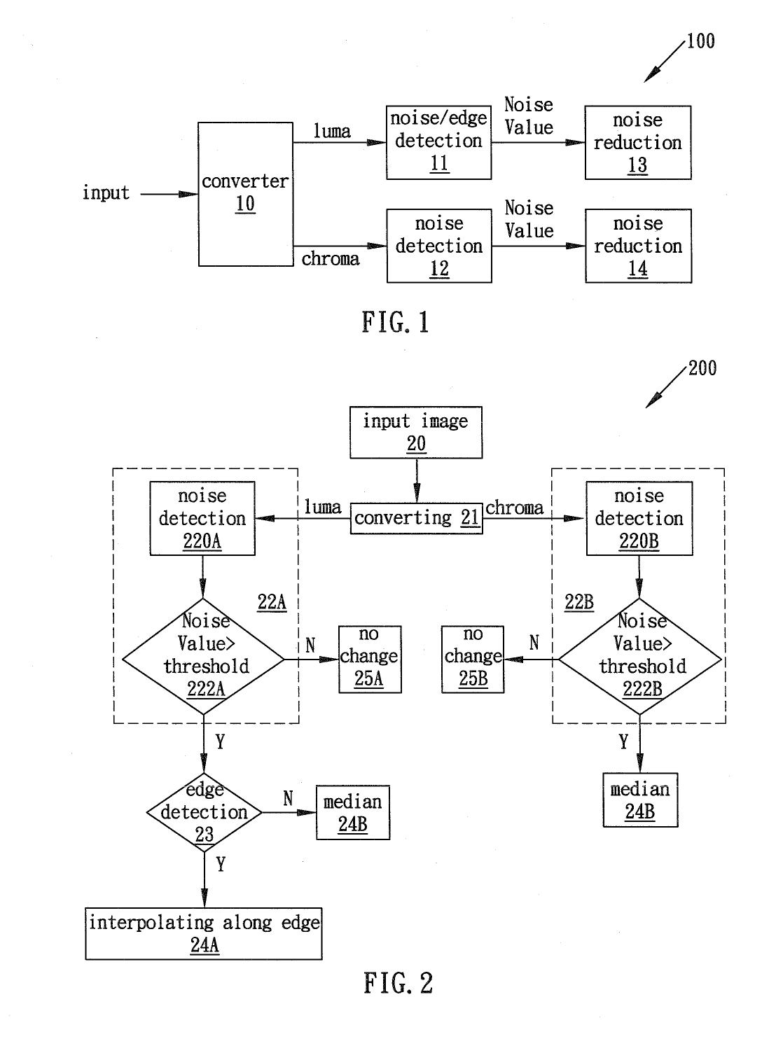

FIG. 1 shows a block diagram illustrating apparatus 100 for noise reduction according to one embodiment of the present invention, and FIG. 2 shows a flow diagram illustrating a method 200 for noise reduction according to the embodiment of the present invention. In the embodiment, the apparatus 100 and method 200 are utilized to effectively reduce or remove noise, especially the impulse noise.

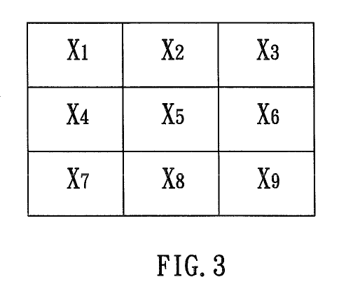

In the embodiment, first of all, input image corrupted by noise is inputted into the apparatus 100 (in step 20). FIG. 3 shows an exemplary and simplified image having 3×3 pixels, among which the pixel X₅ is subjected to noise reduction. The input image is then converted or decomposed into luma component and chroma component by a decompose/convert unit 10 (in step 21). In this specification, the term unit is used to denote a circuit, a piece of program, or their combination. It is apparent that the converting step 21 is no longer necessary if the color space of the input image is already in the luma-chroma format. In the embodiment, the input image, such as an RGB-format image, is decomposed or converted into YCbCr color space. It is appreciated by those skilled in the pertinent art that other color spaces other than YCbCr may be used instead. For example, YUV or YIQ could be well used in the present invention.

For the luma part, the luma component (e.g., Y) is then subjected to noise detection (in step 22A) and edge detection (in step 23) by the noise/edge detection unit 11 (FIG. 1). As the noise and edge are detected, the pixel (for example, X₅ in this example) under processing is then manipulated to reduce its noise by a noise reduction unit 13. The detection is expressed, but not limited to, as follows:

$$\begin{matrix}V = \vert {X}_{5} - {X}_{2} \vert + \vert {X}_{5} - {X}_{8} \vert & ( 1 a ) \\ H = \vert {X}_{5} - {X}_{4} \vert + \vert {X}_{5} - {X}_{6} \vert & ( 1 b ) \\ N E = \vert {X}_{5} - {X}_{3} \vert + \vert {X}_{5} - {X}_{7} \vert & ( 1 c ) \\ N W = \vert {X}_{5} - {X}_{1} \vert + \vert {X}_{5} - {X}_{9} \vert & ( 1 d ) \\ NoiseValue = V + H + N E + N W & ( 1 e )\end{matrix}$$

NoiseValue=V+H+NE+NW (1e)

If NoiseValue>NoiseThreshold

$${X}_{5}^{′} = \{ \begin{matrix}\frac{1}{2} ( {X}_{2} + {X}_{8} ) & if V < H , V < N E , V < N W \\ \frac{1}{2} ( {X}_{4} + {X}_{6} ) & if H < V , H < N E , H < N W \\ \frac{1}{2} ( {X}_{3} + {X}_{7} ) & if N E < V , N E < H , N E < N W \\ \frac{1}{2} ( {X}_{1} + {X}_{9} ) & if N W < V , N W < H , N W < N E \\ median ( neighborhood pixels ) & else\end{matrix} \} \\ else \\ {X}_{5}^{′} = {X}_{5} \qquad ( 1 f )$$

In the exemplified embodiment, in step 220A, vertical noise value V is derived in (1a), horizontal noise value H is derived in (1b), noise value NE along the northeast direction (i.e., X₃-X₅-X₇) is derived in (1c), and noise value NW along the northwest direction (i.e., X₁-X₅-X₉) is derived in (1d). The total noise value (NoiseValue) is obtained by summing up the V, H, NE and NW (1e). Although the image having 3×3 pixels has been illustrated, an image having different dimension (such as 5×5) may be adapted in the present invention. Moreover, direction other than northeast (45°) and northwest (−45° may also be substitutably or additionally used.

Subsequently, in step 222A, the total noise value (NoiseValue) is compared to a predetermined noise threshold (NoiseThreshold). If the total noise value (NoiseValue) is greater than the predetermined noise threshold (NoiseThreshold), indicating that noise exists around the pixel X₅, the edge detection (step 23) is then further performed according to the conditions expressed in (If), followed by correcting the pixel along the detected-edge direction if edge detected (step 24A) or using the median value of all the neighborhood pixels if no edge detected (step 24B); otherwise, the value of the pixel Xs maintains without change (step 25A). Specifically, in the edge detection (step 23), if edge is detected in the vertical direction (i.e., conditions V<H, V<NE, V<NW have been met), the value of the corrected pixel X₅ is equal to, for example, the average of its neighboring pixels (X₂ and X₈) using interpolation method. The manipulation of the pixel along other detected-edge direction is similar to that along the vertical direction.

On the other hand, for the chroma part, the components Cb and Cr are then subjected to noise detection (in step 22B) respectively by the noise detection unit 12 (FIG. 1). As the chroma component contains little edge information, there is no counterpart of the edge detection (step 23). It is apparent that the order of processing the luma component and processing the chroma component(s) may be altered, or even both processes may be concurrently performed. After the noise is detected, the pixel (for example, X₅ in this example) under processing is then manipulated to reduce its noise by a noise reduction unit 14. The detection is expressed, but not limited to, as follows:

$$\begin{matrix}V = \vert {X}_{5} - {X}_{2} \vert + \vert {X}_{5} - {X}_{8} \vert & ( 2 a ) \\ H = \vert {X}_{5} - {X}_{4} \vert + \vert {X}_{5} - {X}_{6} \vert & ( 2 b ) \\ N E = \vert {X}_{5} - {X}_{3} \vert + \vert {X}_{5} - {X}_{7} \vert & ( 2 c ) \\ N W = \vert {X}_{5} - {X}_{1} \vert + \vert {X}_{5} - {X}_{9} \vert & ( 2 d ) \\ NoiseValue = V + H + N E + N W & ( 2 e )\end{matrix}$$

If NoiseValue>NoiseThreshold

$${X}_{5}^{′} = \{ \begin{matrix}median ( neighborhood pixels ) & if NoiseValue > NoiseThreshold \\ {X}_{5} & else\end{matrix} \qquad ( 2 f )$$

In the exemplified embodiment, in step 220B, vertical noise value V is derived in (2a), horizontal noise value H is derived in (2b), noise value NE along the northeast direction (i.e., X₃-X₅-X₇) is derived in (2c), and noise value NW along the northwest direction (i.e., X₁-X₅-X₉) is derived in (2d). The total noise value (NoiseValue) is obtained by summing up the V, H, NE and NW (2e). It is noted that the detection (2a)-(2e) is the same as the detection (1a)-(1e) in this embodiment. Although the denoising window having 3×3 pixels has been illustrated, a window having different dimension (such as 5×5) may be adapted in the present invention. Moreover, direction other than northeast (45°) and northwest (˜45′) may also be substitutably or additionally used.

Subsequently, in step 222B, the total noise value (NoiseValue) is compared to a predetermined noise threshold (NoiseThreshold), which may be different from or the same as the noise threshold in the step 222A. If the total noise value (NoiseValue) is greater than the predetermined noise threshold (NoiseThreshold), indicating that noise exists around the pixel X₅, the pixel is corrected (step 24B); otherwise, the value of the pixel X₅ maintains without change (step 25B). In the embodiment, if the total noise value (NoiseValue) is greater than the predetermined noise threshold (NoiseThreshold), the value of the corrected pixel Xs is equal to, for example, the median of its neighboring pixels (such as pixels X1, X₂, X₃, X₄; X₆, X₇, X₈, and X₉).

The noise-corrected luma component and chroma component(s) may be subsequently converted into another suitable color space, if needed; and may be displayed, stored, or transferred for further digital image processing.

Accordingly, the embodiment of the present invention provides a nonlinear method, which is fast and effective for noise reduction while preserving the edges and detail information. The embodiment can be implemented as a de-noising filter in hardware, software, or their combination, to effectively remove noise without blurring the edge and details in the image.

Although specific embodiments have been illustrated and described, it will be appreciated by those skilled in the art that various modifications may be made without departing from the scope of the present invention, which is intended to be limited solely by the appended claims.

What is claimed is:

1. Apparatus for noise reduction, comprising:
a detector for detecting noise and edge of luma component of a pixel, and detecting noise of chroma component of the pixel; and
a noise reduction unit for removing the noise from the luma and the chroma components according to the detected noise and the detected edge.

2. The apparatus of claim 1, further comprising a converter for decomposing a pixel of an input image into the luma component and the chroma component.

3. The apparatus of claim 1, wherein the luma component and the chroma component of the pixel are in a YCbCr color space.

4. The apparatus of claim 1, wherein the detector generates total noise value along vertical, horizontal, northeast, and northwest direction.

5. The apparatus of claim 4, wherein the noise reduction unit removes the noise at the pixel when the total noise value is greater than a predetermined noise threshold, otherwise the pixel maintains without change.

6. The apparatus of claim 5, wherein the noise reduction unit removes the noise by interpolating the luma component of the pixel using neighboring pixels along the detected edge if edge detected or using median value of all the neighborhood pixels if no edge detected.

7. The apparatus of claim 5, wherein the noise reduction unit removes the noise of the chroma component by obtaining median of neighboring pixels of the pixel.

8. A method for noise reduction, comprising:
detecting noise and edge of luma component of a pixel, and detecting noise of chroma component of the pixel; and
removing the noise from the luma and the chroma components according to the detected noise and the detected edge.

9. The method of claim 8, further comprising a step of decomposing a pixel of an input image into the luma component and the chroma component.

10. The method of claim 8, wherein the luma component and the chroma component of the pixel are in a YCbCr color space.

11. The method of claim 8, wherein the step of detection generates total noise value along vertical, horizontal, northeast, and northwest direction.

12. The method of claim 11, wherein the step of removing the noise removes the noise at the pixel when the total noise value is greater than a predetermined noise threshold, otherwise the pixel maintains without change.

13. The method of claim 12, wherein the step of removing the noise removes the noise by interpolating the luma component of the pixel using neighboring pixels along the detected edge if edge detected or using median value of all the neighborhood pixels if no edge detected.

14. The method of claim 12, wherein the step of removing the noise removes the noise of the chroma component by obtaining median of neighboring pixels of the pixel.
